(19) United States
(12) Patent Application Publication
(10) Pub. No.: US 2021/0122235 A1
(43) Pub. Date: Apr. 29, 2021

(54) DIESEL EXHAUST FLUID TANK

(71) Applicant: Mayville Engineering Company Inc., Mayville, WI (US)

(72) Inventors: Thomas Cunningham, Mayville, WI (US); Frank Castanon, Atkins, VA (US); David Castanon, Atkins, VA (US); Evan Hearl, Atkins, VA (US); Ryan Raber, Mayville, WI (US)

(21) Appl. No.: 17/078,610

(22) Filed: Oct. 23, 2020

Related U.S. Application Data
(60) Provisional application No. 62/925,075, filed on Oct. 23, 2019.

(51) Int. Cl. B60K 15/073; B60K 13/04; B23K 31/02; F16B 5/08

(52) U.S. Cl. CPC B60K 15/073; B60K 13/04; B60K 2015/03032; F16B 5/08; B23K 31/02

(57) ABSTRACT

Systems and apparatuses include a fuel tank structured to be coupled to a vehicle, a diesel exhaust fluid tank, and a tank coupling system rigidly coupling the diesel exhaust fluid tank to the fuel tank.

### CROSS REFERENCE TO RELATED APPLICATIONS

This application claims the benefit of U.S. Provisional Patent Application No. 62/925,075 filed on Oct. 23, 2019, the entire contents of which are incorporated herein by reference.

### TECHNICAL FIELD

The present disclosure relates to fluid tanks. More particularly, the present disclosure relates to systems and methods for vehicle mounted fluid tanks.

### BACKGROUND

Diesel Exhaust Fluid (DEF) is used in a Selective Catalytic Reduction (SCR) system of an exhaust gas aftertreatment system to convert nitrogen oxides into diatomic nitrogen and water. SCR systems include a catalyst and a DEF dosing system that introduces DEF (e.g., an ammonia or urea solution) into a stream of exhaust gases upstream of the catalyst.

### SUMMARY

One embodiment relates to a system that includes a fuel tank structured to be coupled to a vehicle, a diesel exhaust fluid tank, and a tank coupling system rigidly coupling the diesel exhaust fluid tank to the fuel tank.

Another embodiment relates to a diesel exhaust fluid tank mounting system that includes a diesel exhaust fluid tank including a recess and defining an outer profile matching an associated fuel tank, a bar structured to be welded to the fuel tank with a weld, and a strap sized to be received with in the recess and fastened to the bar to support to the diesel exhaust fluid tank.

Another embodiment relates to a method that includes rigidly mounting a fuel tank to a vehicle, welding a first bar with a first weld contacting four sides of the first bar, welding a second bar with a second weld contacting four sides of the second bar, welding a third bar with a third weld contacting four sides of the third bar, positioning a T-shaped strap in a corresponding recess of a diesel exhaust fluid tank, fastening the strap to the diesel exhaust fluid tank, and fastening the strap to the first bar, the second bar, and the third bar to support the diesel exhaust fluid tank without directly coupling the diesel exhaust fluid tank to the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a top, back, right perspective view of a fuel and DEF tank system according to some embodiments.

FIG. 2 is a top, front, right perspective view of the fuel and DEF tank system of FIG. 1.

FIG. 3 is an exploded view of the fuel and DEF tank system of FIG. 1.

FIG. 4 is a left side view of the fuel and DEF tank system of FIG. 1.

FIG. 5 is a right side view of the fuel and DEF tank system of FIG. 1.

FIG. 6 is a front view of the fuel and DEF tank system of FIG. 1.

FIG. 7 is a rear view of the fuel and DEF tank system of FIG. 1.

FIG. 8 is a bottom view of the fuel and DEF tank system of FIG. 1.

FIG. 9 is a top view of the fuel and DEF tank system of FIG. 1.

FIG. 10 is a top, back, right perspective view of a fuel and DEF tank system according to some embodiments.

FIG. 11 is a top, front, right perspective view of the fuel and DEF tank system of FIG. 10.

FIG. 12 is an exploded view of the fuel and DEF tank system of FIG. 10.

FIG. 13 is a left side view of the fuel and DEF tank system of FIG. 10.

FIG. 14 is a right side view of the fuel and DEF tank system of FIG. 10.

FIG. 15 is a top view of the fuel and DEF tank system of FIG. 10.

FIG. 16 is a rear view of the fuel and DEF tank system of FIG. 10.

FIG. 17 is a bottom view of the fuel and DEF tank system of FIG. 10.

FIG. 18 is a front view of the fuel and DEF tank system of FIG. 10.

FIG. 19 is a top, back, right perspective view of a fuel and DEF tank system according to some embodiments.

FIG. 20 is a top, front, right perspective view of the fuel and DEF tank system of FIG. 19.

FIG. 21 is an exploded view of the fuel and DEF tank system of FIG. 19 with a strap removed.

FIG. 22 is a perspective view of the strap of the fuel and DEF tank system of FIG. 19.

FIG. 23 is a top view of the fuel and DEF tank system of FIG. 19.

FIG. 24 is a front view of the fuel and DEF tank system of FIG. 19.

FIG. 25 is a bottom view of the fuel and DEF tank system of FIG. 19.

FIG. 26 is a rear view of the fuel and DEF tank system of FIG. 19.

FIG. 27 is a left side view of the fuel and DEF tank system of FIG. 19.

FIG. 28 is a right side view of the fuel and DEF tank system sof FIG. 19.

FIG. 29 is a top, front, right perspective view of a fuel tank and DEF tank system of according to some embodiments.

FIG. 30 is a front, left, bottom perspective view of the DEF tank system of FIG. 29.

FIG. 31 is a front, left, bottom perspective view of a DEF tank of the DEF tank system of FIG. 29.

FIG. 32 is a front, left, bottom perspective view of a strap assembly of the DEF tank system of FIG. 29.

FIG. 33 is a front view of the fuel tank and bars of the DEF tank system of FIG. 29.

FIG. 34 is a top, front, right perspective view of a DEF tank system of according to some embodiments

### DETAILED DESCRIPTION

Following below are more detailed descriptions of various concepts related to, and implementations of, apparatuses and systems for fuel and DEF tanks. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various embodiments disclosed herein relate to systems and apparatuses for coupling a DEF tank to a diesel fuel tank to provide a compact dual tank with a reduced weight when compared to typical two tank systems. The fuel and DEF tank system minimizes the weight and space required to mount both a diesel fuel tank and a DEF tank on a vehicle frame. The fuel and DEF tank system also reduces the cost of the system compared to typical tank solutions and simplifies installation.

As utilized herein, the term “diesel exhaust fluid” means a solution used as a consumable in a selective catalytic reduction system.

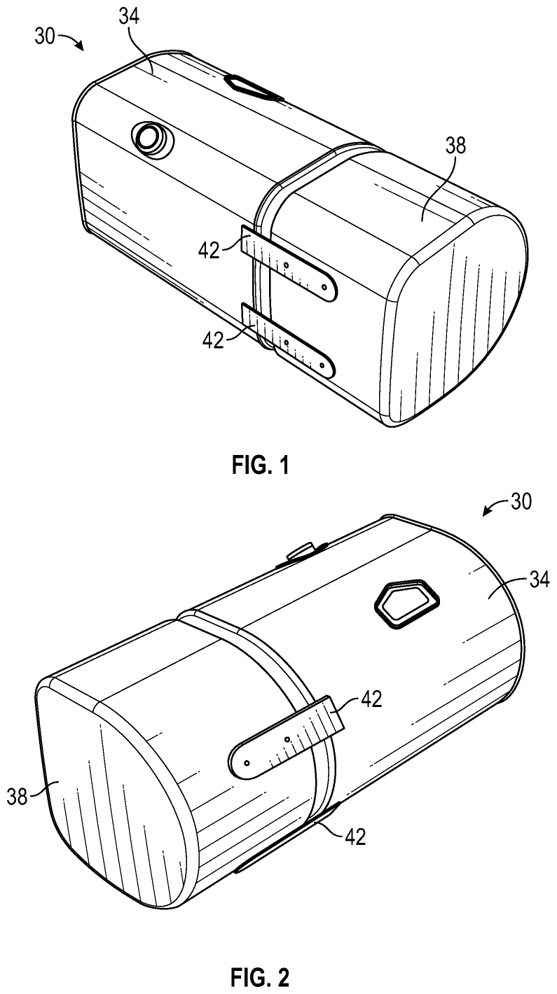

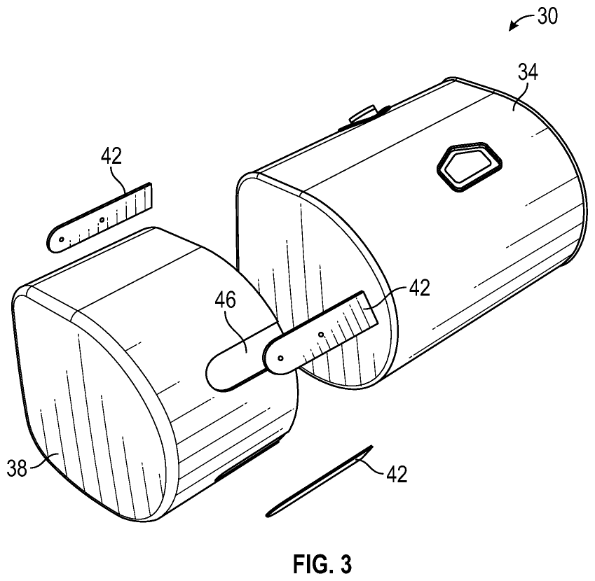

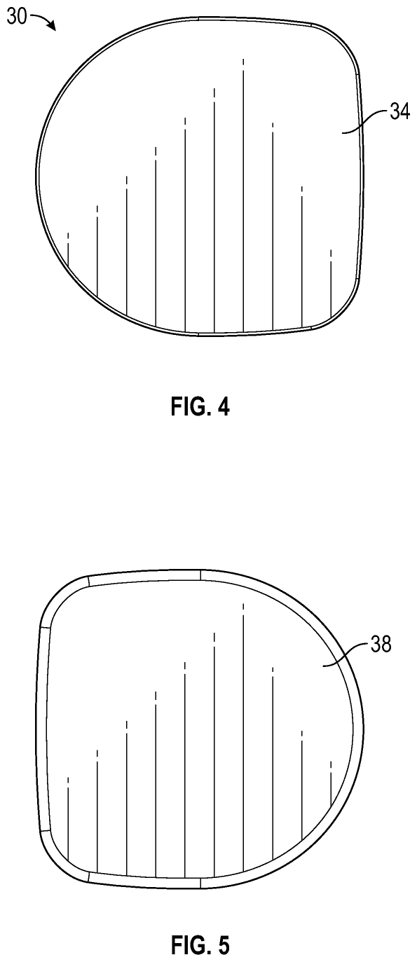

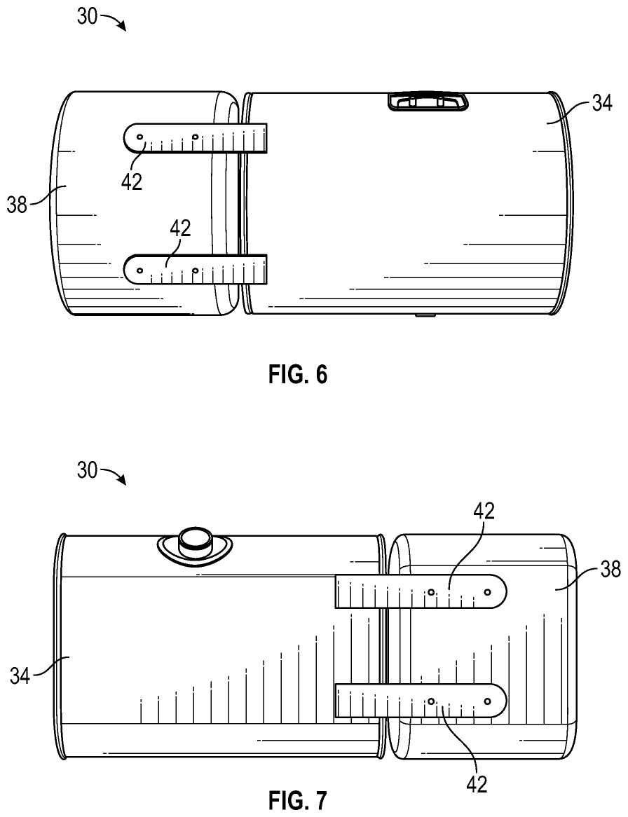

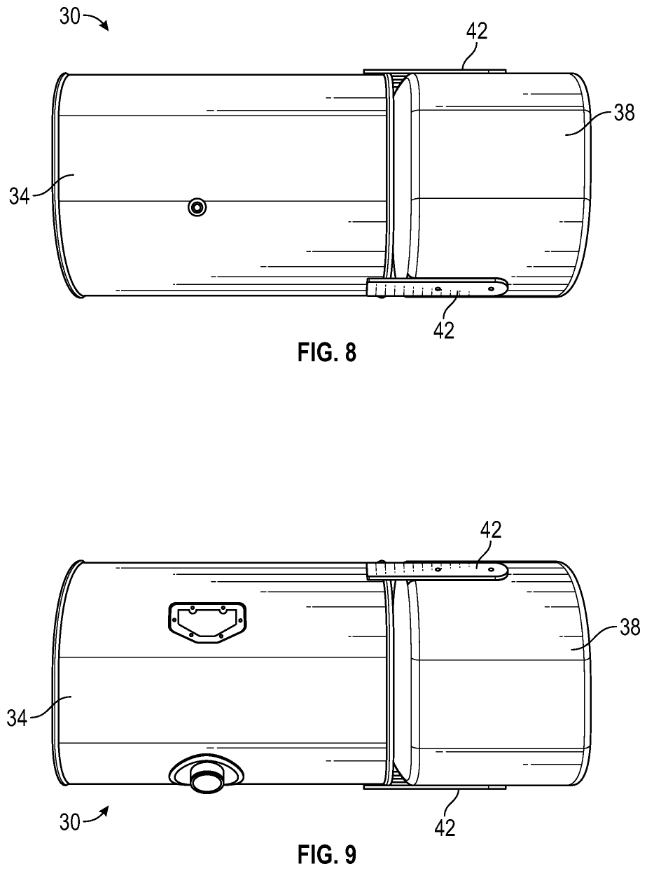

As shown in FIG. 1, a fuel and DEF tank system 30 includes a fuel tank 34, a DEF tank 38 and a tank coupling system in the form of circumferentially connected tabs 42. In some embodiments, the fuel tank 34 is formed from metal (e.g., steel) and the DEF tank is formed from a plastic material (e.g., high density polyethylene (HDPE)). The fuel tank 34 and the DEF tank 38 can include bosses or other features structured to receive tubing, sensors, valves, and/or other accessories.

In some embodiments, the circumferentially connected tabs 42 are formed from steel and welded to the fuel tank 34. The tabs 42 include apertures sized to receive fasteners for connecting to the DEF tank 38 so that the fuel tank 34 and the DEF tank 38 are rigidly coupled together.

In some embodiment, the fuel tank 34 and the DEF tank 38 define a uniform outer profile. In other words the shape of the DEF tank 38 is substantially similar to the shape of the fuel tank 34 so that the fuel and DEF tank system 30 provides the overall appearance of a single unit.

As shown in FIG. 3, the DEF tank 38 includes recesses 46 sized and shaped to receive the tabs 42. The recesses 46 allow the tabs 42 to be arranged flush with an outer surface of the fuel and DEF tank system 30. In some embodiments, the DEF tank 38 includes bosses or mounted fasteners arranged within the recesses 46 that align with apertures in the tabs 42 to allow the tabs 42 to be fastened to the DEF tank 38.

In some embodiments, the fuel and DEF tank system 30 includes four circumferentially connected tabs 42. In some embodiments, the fuel and DEF tank system 30 includes more than four or less than four circumferentially connected tabs 42.

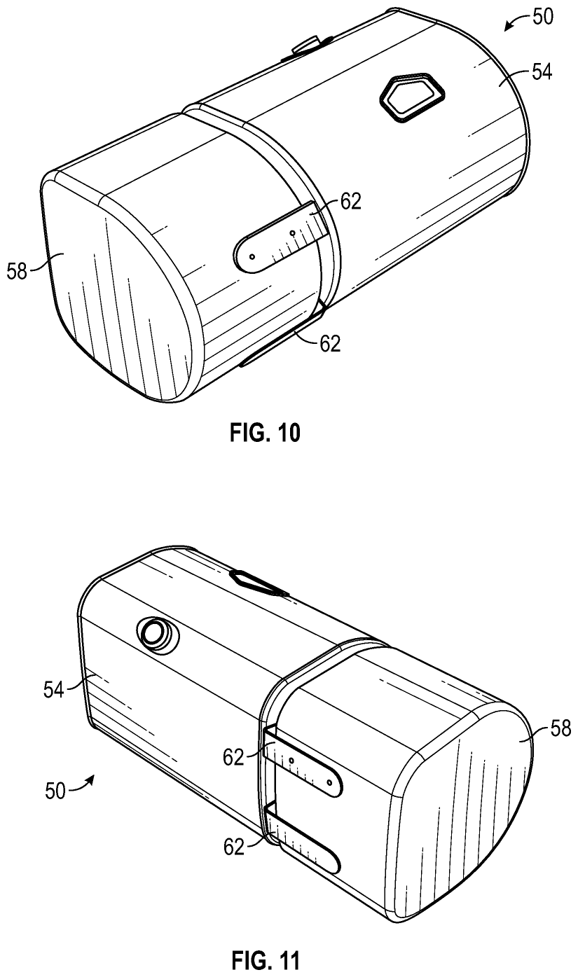

As shown in FIG. 10, another fuel and DEF tank system 50 includes a fuel tank 54, a DEF tank 58 and a tank coupling system in the form of head connected tabs 62. In some embodiments, the fuel tank 54 is formed from metal (e.g., steel) and the DEF tank is formed from a plastic material (e.g., high density polyethylene (HDPE)). The fuel tank 54 and the DEF tank 58 can include bosses or other features structured to receive tubing, sensors, valves, and/or other accessories.

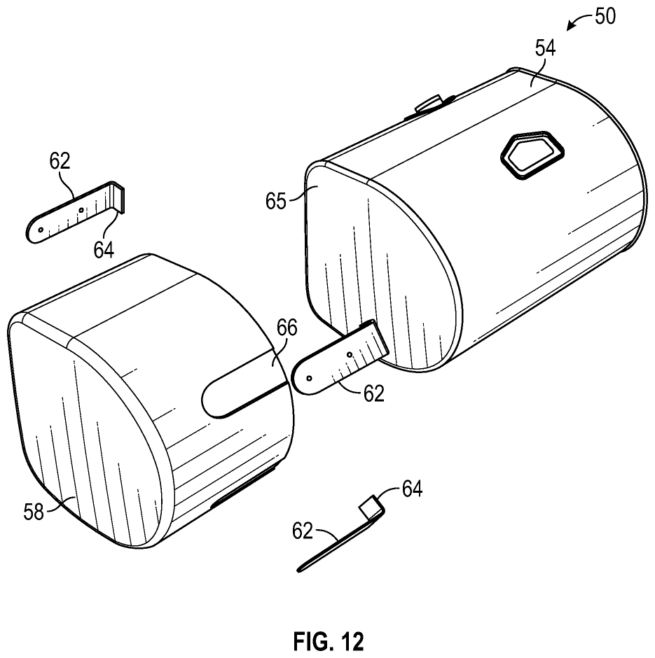

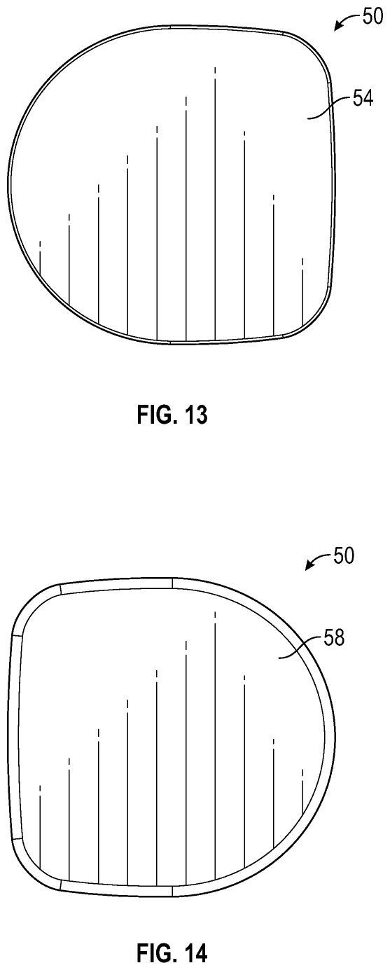

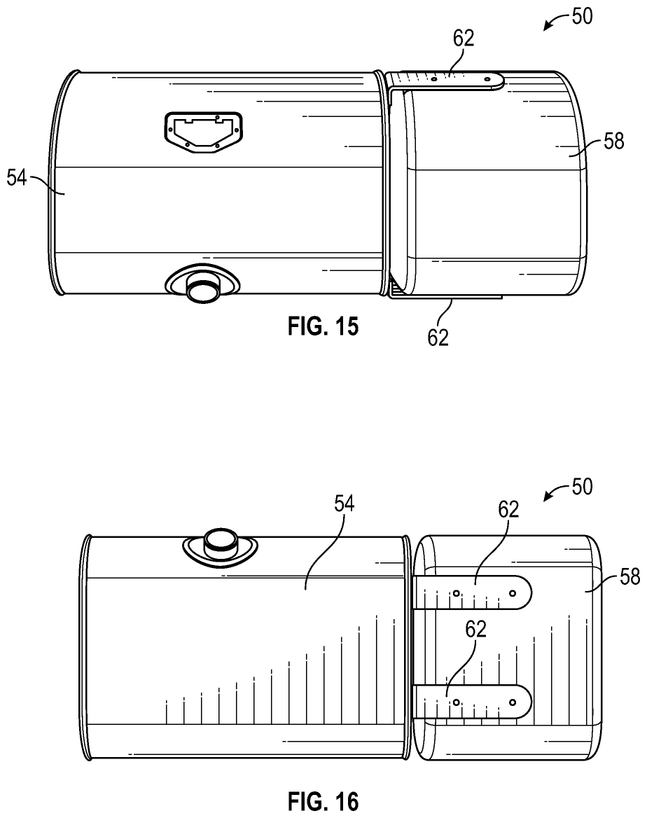

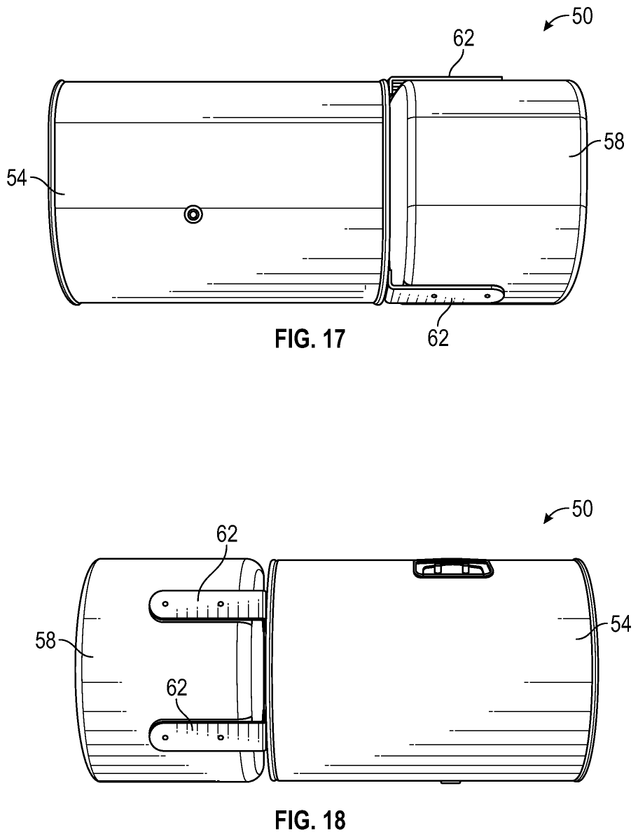

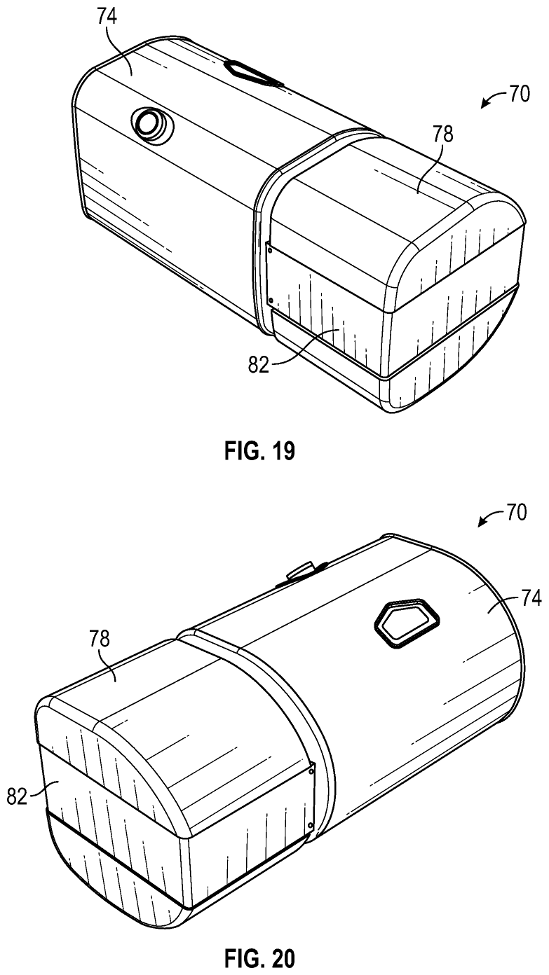

In some embodiments, the head connected tabs 62 are formed from steel and welded to the fuel tank 54. As shown in FIG. 12, the tabs 62 include apertures sized to receive fasteners for connecting to the DEF tank 58 so that the fuel tank 54 and the DEF tank 58 are rigidly coupled together. The tabs 62 also include a fuel tank coupling portion in the form of a flange 64 that is structured to be coupled to a head end 65 of the fuel tank 54. In some embodiments, the flanges 64 are welded to the head end 65.

In some embodiment, the fuel tank 54 and the DEF tank 58 define a uniform outer profile. In other words the shape of the DEF tank 58 is substantially similar to the shape of the fuel tank 54 so that the fuel and DEF tank system 50 provides the overall appearance of a single unit.

As shown in FIG. 12, the DEF tank 58 includes recesses 66 sized and shaped to receive the tabs 62. The recesses 66 allow the tabs 62 to be arranged flush with an outer surface of the fuel and DEF tank system 50. In some embodiments, the DEF tank 58 includes bosses or mounted fasteners arranged within the recesses 66 that align with apertures in the tabs 62 to allow the tabs 62 to be fastened to the DEF tank 58.

In some embodiments, the fuel and DEF tank system 50 includes four head connected tabs 62. In some embodiments, the fuel and DEF tank system, 30 includes more than four or less than four head connected tabs 62.

As shown in FIG. 19, another fuel and DEF tank system 70 includes a fuel tank 74, a DEF tank 78 and a tank coupling system in the form of strap 82. In some embodiments, the fuel tank 74 is formed from metal (e.g., steel) and the DEF tank is formed from a plastic material (e.g., high density polyethylene (HDPE)). The fuel tank 74 and the DEF tank 78 can include bosses or other features structured to receive tubing, sensors, valves, and/or other accessories.

In some embodiments, the strap 82 is formed from steel and is fastened to the fuel tank 74. As shown in FIG. 21, bars 86 can be welded to the fuel tank 74 and include mounting features structured to couple with the strap 82. In some embodiments, the mounting features include threaded apertures. The DEF tank 78 includes a recess 90 sized and shaped to receive the strap 82. This presents a relatively uniform profile of the DEF tank 78 and strap 82. The contact between the strap 82 and the walls of the DEF tank 78 defining the recess 90 helps to secure the DEF tank 78 to the fuel tank 74 and to limit potential movement of the DEF tank 78 relative to the strap 82.

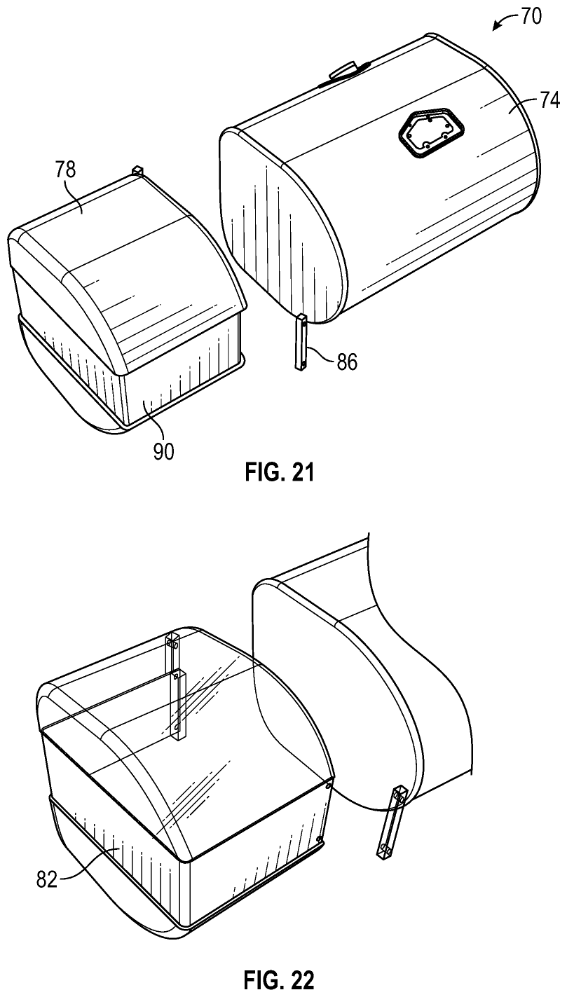

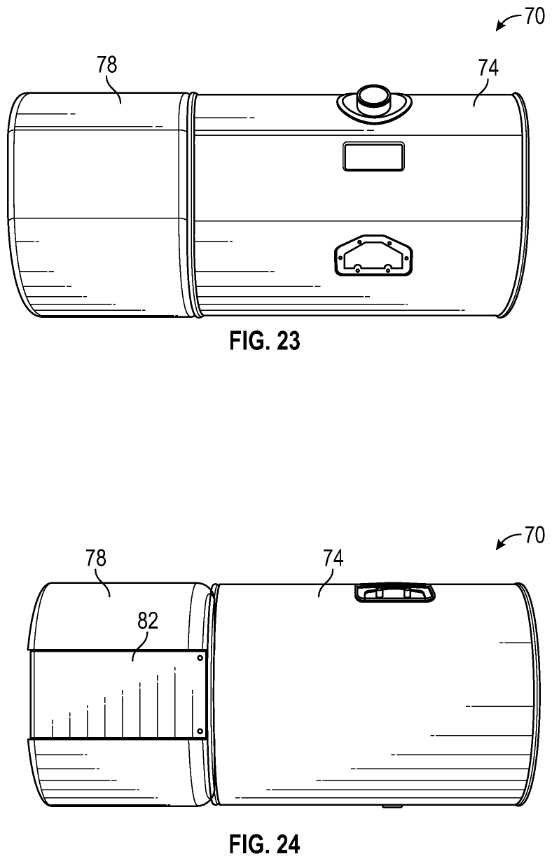

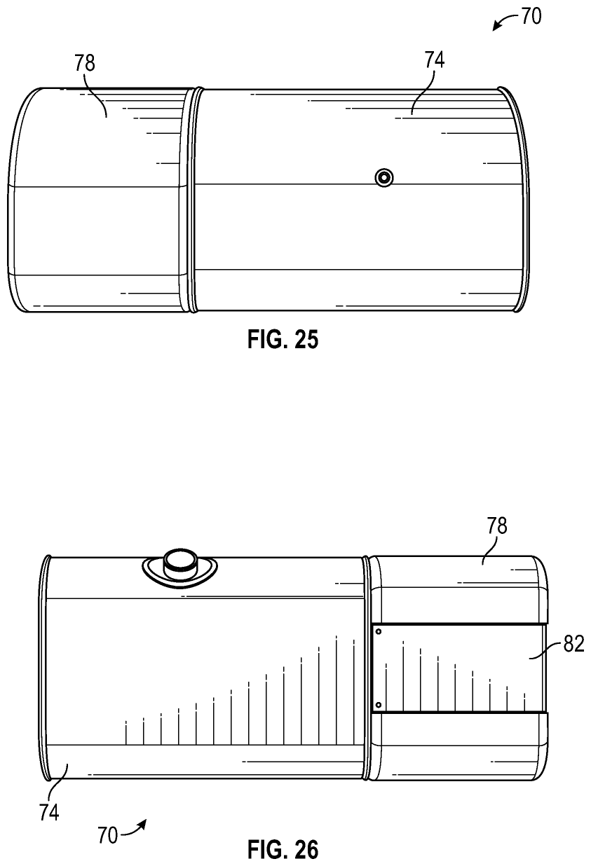

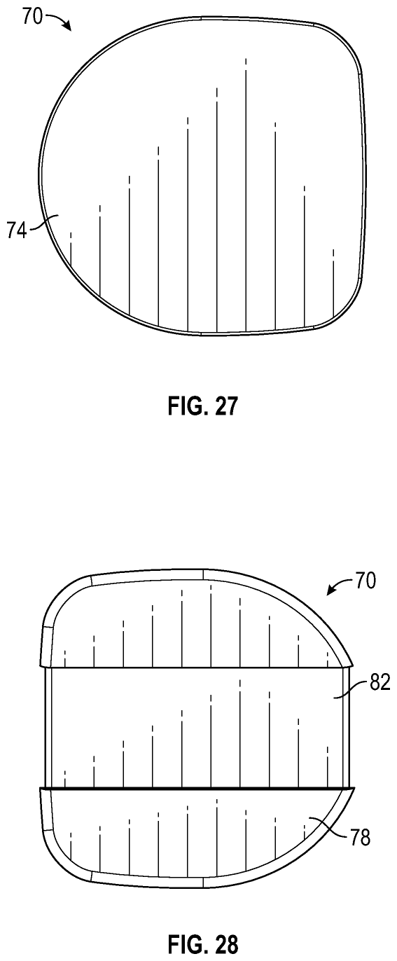

As shown in FIG. 22, the strap 82 include apertures sized to receive fasteners for connecting to the bars 86. The strap 82 is sized to fit in the recess 90 and compressively capture the DEF tank 78 so that the fuel tank 74 and the DEF tank 78 are rigidly coupled together.

In some embodiment, the fuel tank 74 and the DEF tank 78 define a uniform outer profile. In other words the shape or outer perimeter of the DEF tank 78 is substantially similar to the shape or outer perimeter of the fuel tank 74 so that the fuel and DEF tank system 70 provides the overall appearance of a single unit.

In some embodiments, the fuel and DEF tank system 70 includes one strap 82. In some embodiments, the fuel and DEF tank system 30 includes more than one strap 82.

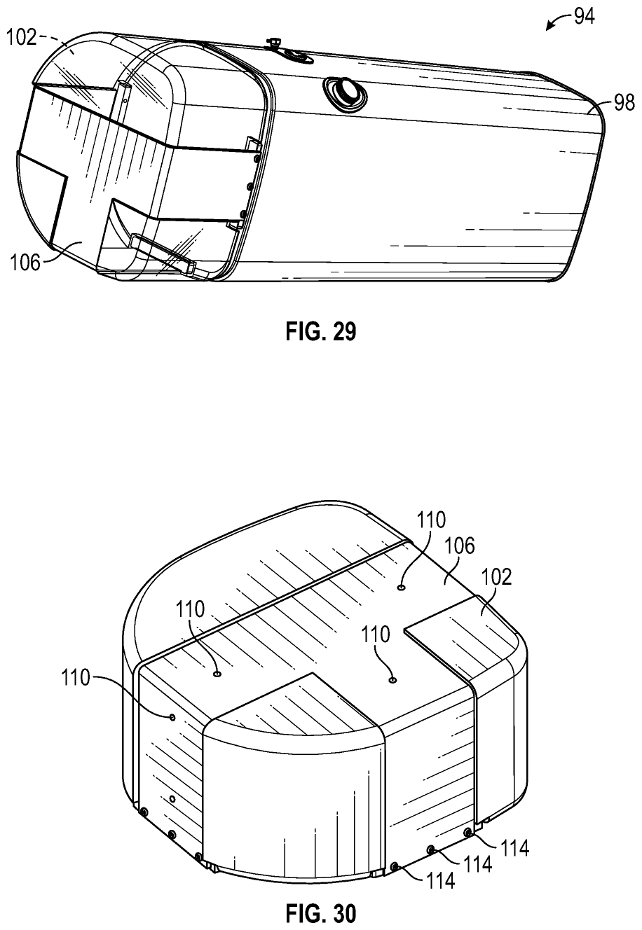

As shown in FIG. 29, another fuel and DEF tank system 94 includes a fuel tank 98, a DEF tank 102 and a tank coupling system in the form of strap 106. In some embodiments, the fuel tank 98 is formed from metal (e.g., steel) and the DEF tank 102 is formed from a plastic material (e.g., high density polyethylene (HDPE)). In some embodiments, an endcap of the fuel tank 98 adjacent the DEF tank 102 defines a thickness of about 0.125 inches.

As shown in FIG. 30, the strap 106 includes apertures 110 sized to receive fasteners for coupling to the DEF tank 102. In some embodiments, the apertures are through holes sized to receive bolts. The strap 106 also includes apertures 114 sized to receive fasteners for coupling the strap 106 (and therefore the DEF tank 102) to the fuel tank 98. In some embodiments, each leg of the strap 106 includes three apertures 114 that are spaced at least a quarter inch from an edge of the strap 106. Washers can be used along with the fasteners to further distribute load at the apertures 114. The strap 106 defines a general T-shape with three legs coupling to the fuel tank 98. Each leg includes three apertures 114. One leg of the T-shape is arranged vertically toward a lower side of the DEF tank 102. The strap 106 is sized and shaped to match the contours of the DEF tank 102. In some embodiments, the strap 106 is formed from Gr 50 steel.

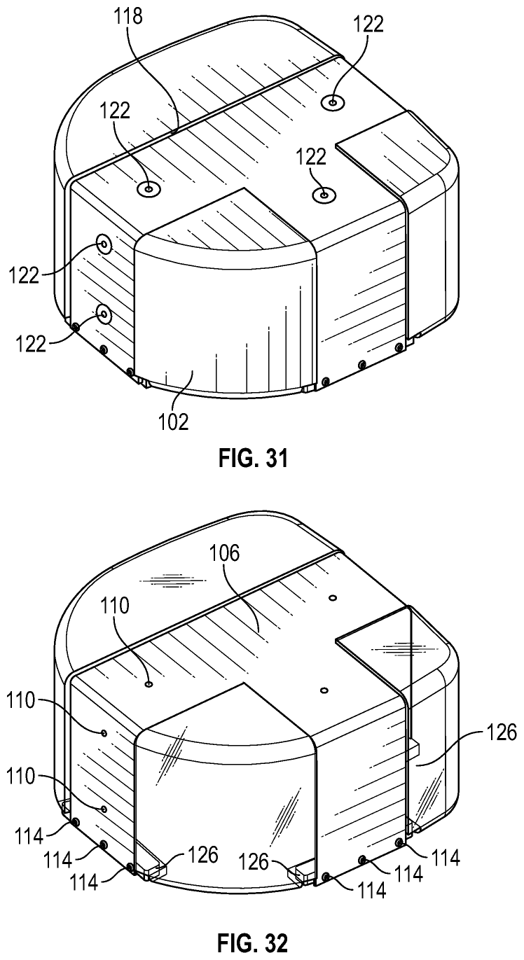

As shown in FIG. 31, the DEF tank 102 defines a recess 118 shaped to receive the strap 106. Additionally, the DEF tank 103 includes bosses 122 sized and positioned to align with the apertures 110 of the strap 106 and to receive fasteners for coupling the strap 106 to the DEF tank 102. In some embodiments, the bosses 122 are threaded nuts that are molded into a plastic body of the DEF tank 102. In some embodiments, the bosses 122 are replaced with studs that are sized to project through the apertures 110 of the strap 106. In some embodiments, the recess 118 is sized so that the strap 106 is substantially flush with the exterior surface of the remainder of the DEF tank 102. The contact between the strap 106 and the walls of the DEF tank 102 defining the recess 118 helps to secure the DEF tank 102 to the fuel tank 98 and to limit potential movement of the DEF tank 102 relative to the strap 106.

The outer profile of the DEF tank is shaped to match the fuel tank 98. For example, the fuel tank 98 shown in FIG. 29 is generally D-shaped and the DEF tank matches this profile. In some embodiments, the fuel tank is square in profile, round in profile, or defines another profile. The DEF tank 102 is structured and shaped to match the outer profile of the fuel tank 98 to aid in fitment with a vehicle for installation. Often the vehicle mounting position will be adapted to receive the designed shape of the fuel tank 98 and matching the profile of the DEF tank 102 thereto simplifies installation and fitment.

As shown in FIG. 32, the strap 106 is fastened to the fuel tank 98 using bars 126 that are welded to the fuel tank 98 and include mounting features structured to couple with the strap 106. In some embodiments, the bars 126 each include three threaded apertures aligned with the three apertures 114 of each leg of the strap 106. In some embodiments, the bars 126 include not sharp corners. For example, the corners may include a round over defining a radius of about a quarter inch. The rounded corners reduce stress risers within the bars 126. In some embodiments, the bars 126 define a thickness of about three-quarters of an inch.

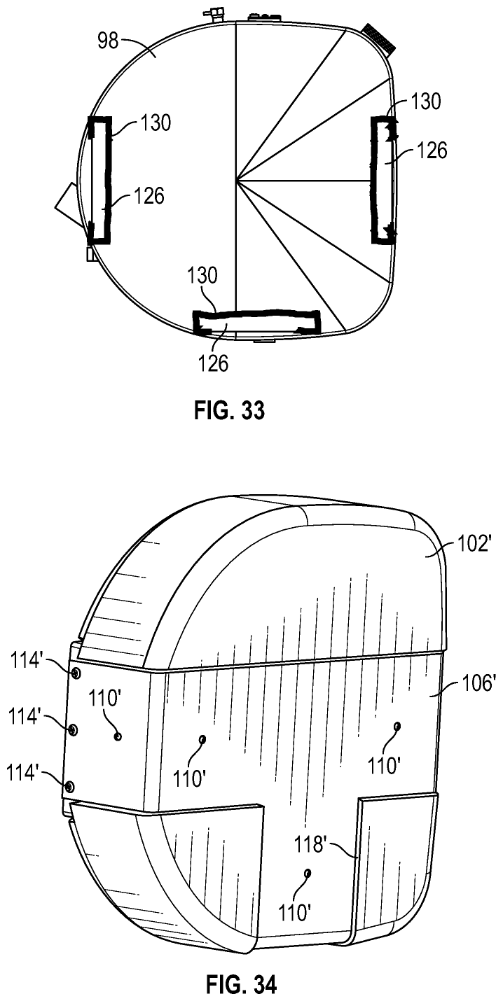

As shown in FIG. 33, the bars 126 are welded to the end cap of the fuel tank 98 along a weld profile 130 that contacts four sides of the bar 126. In some embodiments, the weld profile 130 only encompasses three sides of the bars 126 or less. In some embodiments, the bars 126 may additionally or alternatively be coupled to the fuel tank 98 via fasteners or adhesives. In some embodiments, the weld size is about a quarter inch. In some embodiments, the weld size is 0.10 inches or greater.

The fuel tank 98 is structured to be rigidly mounted to a frame of a vehicle at mounting points. The DEF tank mounting system including the strap 106 and the DEF tank 102 are structured to be supported directly by the fuel tank 102 with no additional mounting points to the vehicle or the frame of the vehicle. The DEF tank mounting system is structured so that all components (e.g., the DEF tank 102, the strap 106, the bars 126, the welds 130, and the fasteners) remain within elastic yield limits when exposed to five gravitational force equivalents (5 G's) in all axis assuming a full DEF tank 102 and a liquid density therein of 9.05 lbs/gal.

The DEF tank 102 shown in FIGS. 29-33 defines a volume of one hundred seven liters (107 L). The DEF tanks described herein can be adapted to other volumes. For example, a DEF tank 102′ shown in FIG. 34 defines a volume of forty five liters (45 L). The strap 106′ and other components are altered to fit the DEF tank 102′. Other DEF tank sizes are contemplated within the scope of this disclosure and can be adapted to any size or shape fuel tank.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the fuel and DEF tank systems as shown in the various exemplary embodiments is illustrative only. Additionally, any element disclosed in one embodiment may be incorporated or utilized with any other embodiment disclosed herein. For example, the circumferentially connected straps 42 of the exemplary embodiment described above may be incorporated in or used along with the head connected straps 62 of the exemplary embodiment described above. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An system, comprising:
a fuel tank structured to be coupled to a vehicle;
a diesel exhaust fluid tank; and
a tank coupling system rigidly coupling the diesel exhaust fluid tank to the fuel tank.

2. The system of claim 1, wherein the fuel tank and the diesel exhaust fluid tank define a uniform external profile.

3. The system of claim 1, wherein the diesel exhaust fluid tank defines a recess sized to receive the tank coupling system.

4. The system of claim 1, wherein the tank coupling system includes a strap sized to capture the diesel exhaust fluid tank to rigidly couple the diesel exhaust fluid tank to the fuel tank.

5. The system of claim 4, wherein the tank coupling system further includes a bar rigidly coupled to the fuel tank.

6. The system of claim 5, wherein the bar is welded to the fuel tank.

7. The system of claim 6, wherein a weld profile contacts four sides of the bar.

8. The system of claim 4, wherein the strap defines a T-shape with one leg arranged vertically downward.

9. The system of claim 8, wherein each leg of the T-shape defines three apertures sized to receive fasteners.

10. A diesel exhaust fluid tank mounting system comprising:
a diesel exhaust fluid tank including a recess and defining an outer profile matching an associated fuel tank;
a bar structured to be welded to the fuel tank with a weld; and
a strap sized to be received with in the recess and fastened to the bar to support to the diesel exhaust fluid tank.

11. The diesel exhaust fluid tank mounting system of claim 10, wherein the bar is a first bar, and further comprising a second bar and a third bar.

12. The diesel exhaust fluid tank mounting system of claim 10, wherein the strap defines a T-shape.

13. The diesel exhaust fluid tank mounting system of claim 10, wherein the weld contacts four sides of the bar.

14. The diesel exhaust fluid tank mounting system of claim 10, wherein the bar includes rounded corners.

15. The diesel exhaust fluid tank mounting system of claim 10, wherein the strap and the bar are structured to remain in an elastic yield range when exposed to five gravitational force equivalents assuming a full diesel exhaust fluid tank and a liquid density therein of 9.05 lbs/gal.

16. The diesel exhaust fluid tank mounting system of claim 10, wherein the diesel exhaust fluid tank is not coupled directly to a vehicle.

17. The diesel exhaust fluid tank mounting system of claim 10, wherein the diesel exhaust fluid tank includes bosses molded therein and the strap is fastened to the bosses.

18. The diesel exhaust fluid tank mounting system of claim 10, wherein the diesel exhaust fluid tank is formed of a plastic and the strap is formed of a steel.

19. The diesel exhaust fluid tank mounting system of claim 10, wherein the recess is sized so that an outer surface of the strap and an outer surface of the diesel exhaust fluid tank are substantially flush.

20. A method comprising:
rigidly mounting a fuel tank to a vehicle;
welding a first bar with a first weld contacting four sides of the first bar;
welding a second bar with a second weld contacting four sides of the second bar;
welding a third bar with a third weld contacting four sides of the third bar;
positioning a T-shaped strap in a corresponding recess of a diesel exhaust fluid tank;
fastening the strap to the diesel exhaust fluid tank; and
fastening the strap to the first bar, the second bar, and the third bar to support the diesel exhaust fluid tank without directly coupling the diesel exhaust fluid tank to the vehicle.
